(19) United States
(12) Patent Application Publication
(10) Pub. No.: US 2016/0137080 A1
(43) Pub. Date: May 19, 2016

(54) APPARATUS AND METHOD FOR CHARGING BATTERY FOR VEHICLE

(71) Applicant: Hyundai Motor Company, Seoul (KR)

(72) Inventors: Hui Sung Jang, Hwaseong (KR); Hyun Wook Seong, Hwaseong (KR); Shin Hye Chun, Gwangyang (KR); Mu Shin Kwak, Osan (KR)

(21) Appl. No.: 14/628,899

(22) Filed: Feb. 23, 2015

(30) Foreign Application Priority Data
Nov. 13, 2014 (KR) 10-2014-0157940

(51) Int. Cl. B60L 11/18

(52) U.S. Cl. CPC B60L 11/1816; B60L 11/1811; B60L 11/1861

(57) ABSTRACT

An apparatus and a method for charging a battery for a vehicle are provided. The apparatus includes a power factor correction circuit that is configured to distribute charging power output from a charging device, which is connected to a power source, to multiple phases, and to correct a power factor of charging power distributed to the respective phases. In addition, a controller is configured to operate the power factor correction circuit to distribute charging power to some of the multiple phases based on the charging device or the charging power of the charging device.

### CROSS-REFERENCE(S) TO RELATED APPLICATIONS

The present application claims priority of Korean Patent Application Number 10-2014-0157940 filed on Nov. 13, 2014, the entire contents of which application are incorporated herein for all purposes by this reference.

### BACKGROUND

1. Field of the Invention

The present invention relates to an apparatus and a method for charging a battery for a vehicle which has an improved charging efficiency by controlling a power factor correction circuit based on a charging device connected to a power source.

2. Description of Related Art

After the industrialization age, the development of the vehicle industry based on gasoline and diesel fuels causes the acceleration of air pollution due to the exhaust gas of vehicles. Accordingly, recently, various eco-friendly vehicles that generate minimal or no exhaust gas have been developed. These eco-friendly vehicles include a hybrid vehicle, a plug-in hybrid vehicle, an electric vehicle, a fuel cell vehicle, and the like. Among the vehicles, the plug-in hybrid vehicle and the electric vehicle are configured to be charged using a household electric power source, and the two types of vehicles are equipped with on-board battery chargers (OBCs).

An on-board battery charger (OBC) requiring high charging power and using a household electric power source uses a plurality of small inductors for size reduction of an inductor and for the heat-generation characteristics. Two inductors are used to configure a multi-phase interleaved topology. In addition, an on-board battery charger (OBC) employs an electric vehicle supply equipment (EVSE) charging scheme (generally, 6 kW or greater) or an in-cable control box (ICCB) charging scheme (generally, 3.3 kW or less). In both charging schemes, since the power transfer efficiency of the on-board battery charger (OBC) is connected directly with the fuel efficiencies of the electric vehicle and the plug-in hybrid vehicle, a high efficiency is required in a wide charging power range.

When the conventional OBC is charged, a power factor correction circuit using a two-phase interleaved PWM scheme is used, regardless of whether a charging device connected to an alternating current (AC) power source is configured with an EVSE or with an ICCB. However, when the conventional two-phase interleaved pulse width modulation (PWM) scheme is used, when low power is charged as in the ICCB charging scheme, the loss by switching and diode on-drop to the loss by conduction increases, thus decreasing the charging efficiency.

The information disclosed in this section is merely for enhancement of understanding of the general background of the invention and should not be taken as an acknowledgement or any form of suggestion that this information forms the prior art already known to a person skilled in the art.

### SUMMARY

An exemplary embodiment of the present invention is directed to an apparatus and a method for charging a battery for a vehicle which controls a power factor correction circuit in a two-phase or a single-phase PWM scheme based on the type of a charging device, the charging power thereof, or the allowable charging current duty ratio thereof.

Other objects and advantages of the present invention can be understood by the following description, and become apparent with reference to the exemplary embodiments of the present invention. Additionally, it is obvious to those skilled in the art to which the present invention pertains that the objects and advantages of the present invention can be realized by the means as claimed and combinations thereof.

In accordance with an exemplary embodiment of the present invention, an apparatus for charging a battery for a vehicle may include: a power factor correction circuit configured to distribute charging power output from a charging device connected to a power source, to multiple phases, and to correct a power factor of charging power distributed to the respective phases; and a controller configured to operate the power factor correction circuit to distribute charging power to a portion of the multiple phases based on the charging device or the charging power of the charging device.

The controller may be configured to operate the power factor correction circuit to distribute charging power to a portion of the multiple phases when the charging device is an in-cable control box (ICCB). In addition, the controller may be configured to operate the power factor correction circuit to distribute charging power to a portion of the multiple phases when the charging power is less than a preset power. The controller may be configured to operate the power factor correction circuit to distribute charging power to a portion of the multiple phases when an allowable charging current duty ratio of the charging device is less than a preset value.

Further, the controller may be configured to measure a voltage of a rear terminal of the charging device, and to calculate an effective voltage value based on the measured voltage. The power factor correction circuit may be operated to distribute charging power to a portion of the multiple phases when the charging power of the charging device is less than a preset power and the effective voltage value is equal to or greater than a preset voltage. The power factor correction circuit may also be operated to distribute charging power to a portion of the multiple phases when an allowable charging current duty ratio of the charging device is less than a preset value and the effective voltage value is equal to or greater than a preset voltage.

According to an apparatus for charging a battery for a vehicle, having a configuration as described above, since the power factor correction circuit may be switched to a single-phase PWM scheme based on the type of a charging device, the charging power thereof, or the allowable charging current duty ratio thereof, when charging power is substantially low, a switching loss and a diode on-drop may be reduced compared to the prior art using a two-phase interleaved PWM scheme, to improve the charging efficiency.

In addition, a charging efficiency greater than the conventional efficiency may be achieved, thus improving the fuel efficiency of a vehicle, reducing a charging time, and reducing electric charge. In addition, since the present invention may be implemented with the conventional apparatus for charging a battery for a vehicle, even without a separate device added thereto, and a cause of rising cost due to a topology change and added hardware may be removed. In addition, since only one of two phases of the power factor correction circuit is used, the use amount of the other phase may be reduced by half, thus increasing the durability of the power factor correction circuit.

### BRIEF DESCRIPTION OF THE DRAWINGS

The above and other objects, features and advantages of the present disclosure will be more apparent from the following detailed description taken in conjunction with the accompanying drawings:

FIG. 1 is an exemplary block diagram illustrating the configuration of an apparatus for charging a battery for a vehicle in accordance with an exemplary embodiment of the present invention;

FIG. 2 is an exemplary block diagram showing current flow when a power factor correction circuit is in a two-phase PWM scheme in accordance with an exemplary embodiment of the present invention;

FIG. 3 is an exemplary block diagram showing current flow when a power factor correction circuit is in a single-phase PWM scheme in accordance with an exemplary embodiment of the present invention;

FIG. 4 is an exemplary graph showing a charging efficiency to charging power under the control of a power factor correction circuit in accordance with an exemplar embodiment of the present invention;

FIG. 5 is an exemplary graph showing a control condition of a power factor correction circuit based on an effective voltage value and charging power in accordance with an exemplary embodiment of the present invention; and

FIG. 6 is an exemplary graph showing a control condition of a power factor correction circuit based on an effective voltage value and an allowable charging current duty ratio in accordance with an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, an apparatus for charging a battery for a vehicle in accordance with exemplary embodiments of the present invention will be described below in more detail with reference to the accompanying drawings. The present invention may, however, be embodied in different forms and should not be construed as limited to the exemplary embodiments set forth herein. Rather, these exemplary embodiments are provided so that this disclosure will be thorough and complete, and will fully convey the scope of the present invention to those skilled in the art. Throughout the disclosure, like reference numerals refer to like parts throughout the various figures and exemplary embodiments of the present invention.

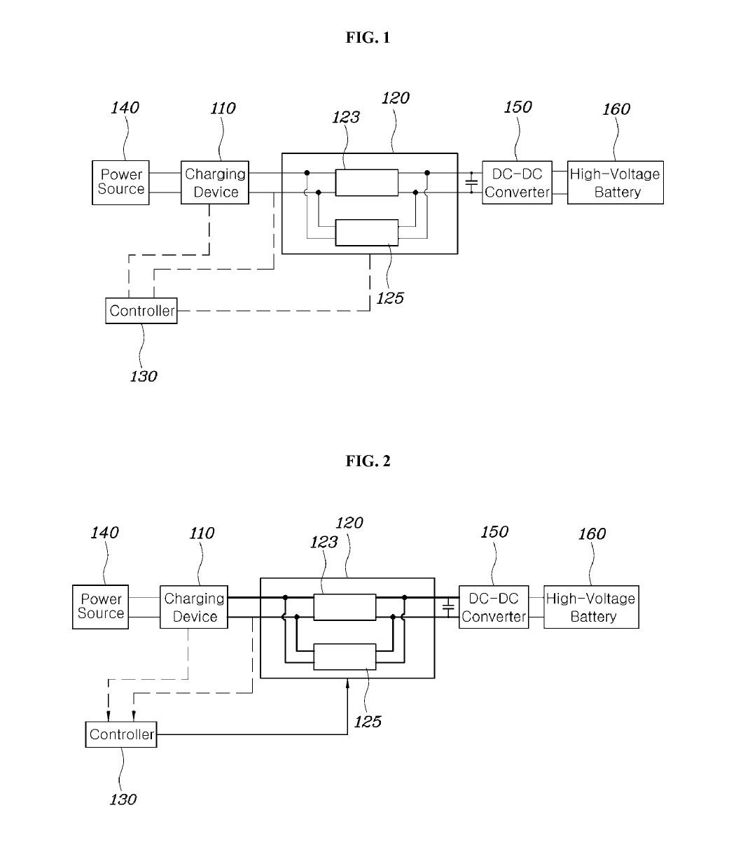

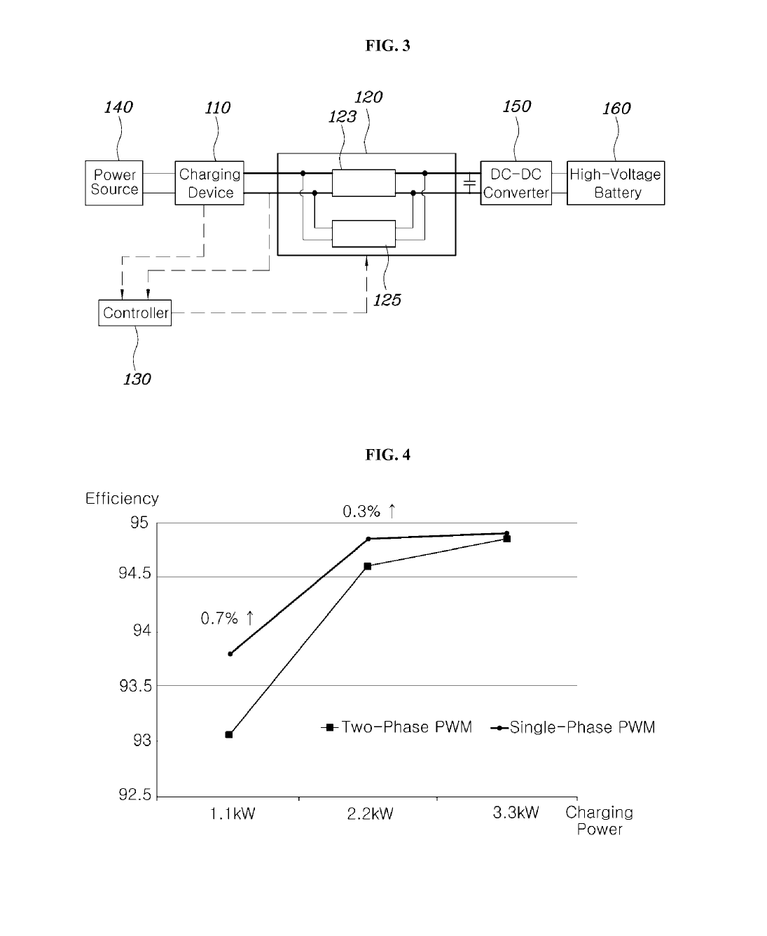

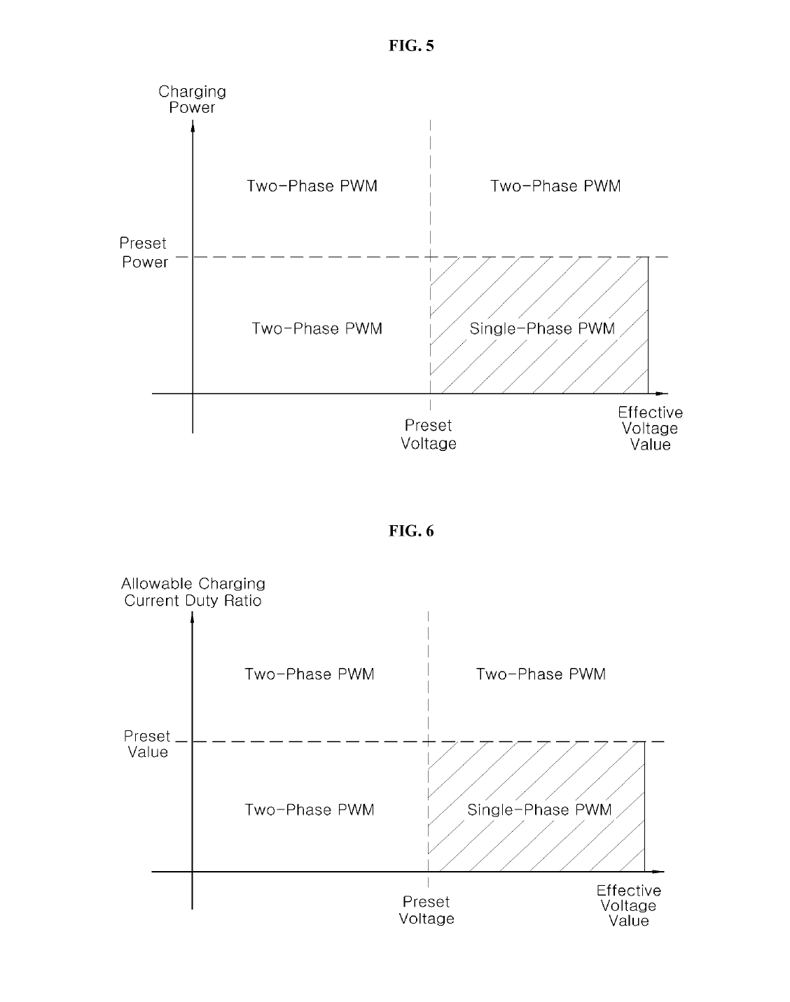

FIG. 1 is an exemplary block diagram illustrating the configuration of an apparatus for charging a battery for a vehicle in accordance with an exemplary embodiment of the present invention, FIG. 2 is an exemplary block diagram showing current flow when a power factor correction circuit is in a two-phase PWM scheme in accordance with an exemplary embodiment of the present invention, FIG. 3 is an exemplary block diagram showing current flow when a power factor correction circuit is in a single-phase PWM scheme in accordance with an exemplary embodiment of the present invention, FIG. 4 is an exemplary graph showing a charging efficiency to charging power under the control of a power factor correction circuit in accordance with an exemplary embodiment of the present invention, FIG. 5 is an exemplary graph showing a control condition of a power factor correction circuit based on an effective voltage value and charging power in accordance with an exemplary embodiment of the present invention, and FIG. 6 is an exemplary graph showing a control condition of a power factor correction circuit based on an effective voltage value and an allowable charging current duty ratio in accordance with an exemplary embodiment of the present invention.

Referring to FIGS. 1 to 6, an apparatus for charging a battery for a vehicle may include: a power factor correction circuit 120 configured to distribute to a plurality of phases charging power output from a charging device 110, which is connected to a power source 140, and configured to correct the power factor of charging power distributed to the respective phases; and a controller 130 configured to operate the power factor correction circuit 120 to distribute the charging power to a portion of the plurality of phases (e.g., to some of the phases, not to all of the phases, etc.) according to the charging device 110 or the charging power of the charging device 110.

The charging device 110 may be supplied with alternating current (AC) power from the power source 140, and may be configured to output charging power with different power values based on charging schemes. In particular, electric vehicle supply equipment (EVSE) or an in-cable control box (ICCB) may be applied to the charging device 110. For example, the EVSE scheme may be configured to output charging power of about 6 kW or greater, and the ICCB scheme is configured to output charging power of about 3.3 kW or less.

The power factor correction circuit 120 may be supplied with charging power output from the charging device 110, may be configured to distribute the charging power to a plurality of phases, and then may be configured to perform a power factor correction. The power factor correction circuit 120 may be configured to use a two-phase interleaved PWM scheme, as in the apparatus for charging a battery for a vehicle which is shown in FIG. 1 in accordance with an exemplary embodiment of the present invention. However, this is merely one example, and the present invention may be applied even to an apparatus for charging a battery for a vehicle which includes a power factor correction circuit 120 having more than two phases.

The charging power output from the power factor correction circuit 120 may be input to a high-voltage battery 160 through a DC-DC converter 150, to charge the high-voltage battery 160 for a vehicle. First, when the charging device 110 is configured with an ICCB, the controller 130 may be configured to operate the power factor correction circuit 120 to distribute charging power to a part of multiple phases.

In the prior art, charging power is distributed to all the multiple phases 123 and 125, regardless of the charging device 110, as shown in FIG. 2. For example, in the prior art, when the charging device 110 is configured with an EVSE, the charging power thereof is 6 kW or greater, and thus charging power of 3 kW is allocated to each phase of the power factor correction circuit 120 through division. When the charging device 110 is configured with an ICCB, the charging power thereof is 3.3 kW or less, and thus charging power of 1.65 kW is allocated to each phase of the power factor correction circuit 120 through division. In other words, in the prior art, even when the charging device 110 is configured with an ICCB, a multi-phase interleaved PWM scheme is applied, to allocate low charging power to each of the multiple phases of the power factor correction circuit 120. Accordingly, when charging is performed, the charging efficiency is reduced.

In contrast, when the charging device 110 is configured with an ICCB, the controller 130 in accordance with an exemplary embodiment of the present invention adjusts charging power to be supplied only to any one of the multiple phases of the power factor correction circuit 120, thereby increasing the charging power applied to the one phase of the power factor correction circuit 120, and improving the charging efficiency.

For example, when the charging device 110 is configured with an ICCB, and the controller 130 operates the power factor correction circuit 120 in a single-phase PWM scheme, as shown in FIG. 3, the charging power of 3.3 kW is applied to one phase 123 of the power factor correction circuit 120, while charging power is not distributed to the other phase 125 (that is, the charging power is only distributed to some of the multiple phases). Accordingly, charging power input to one phase 123 of the power factor correction circuit 120 increases, thus improving the charging efficiency.

According to another control method, when charging power output from the charging device 110 is less than predetermined power, the controller 130 may be configured to operate the power factor correction circuit 120 to apply the charging power to a part of multiple phases (e.g., to at least one of the multiple phases); and when the allowable charging current duty ratio of the charging device 110 is less than a predetermined value, the controller 130 may be configured to operate the power factor correction circuit 120 to apply the charging power to a part of multiple phases. In other words, the controller 130 may be configured perform a control of the power factor correction circuit 120 using the charging power or the allowable charging current duty ratio information of the charging device 110, in addition to a method of determining whether the charging device 110 connected to the aforementioned power source 140 is configured with an EVSE or with an ICCB and performing a control operation. In particular, the allowable charging current duty ratio is a signal that represents the maximum allowable charging current value of the charging device 110.

For example, when receiving information regarding charging power from the charging device 110, the controller 130 may be configured to set the preset power to about 3.3 kW as a reference for determination of low power. In particular, when charging power output from the charging device 110 is about 3.3 kW or less, the controller 130 may be configured to determine that the charging device 110 is configured with an ICCB or that the charging device 110 outputs low power, and thus the power factor correction circuit 120 may be operate to cause charging current to flow to one phase. In contrast, when charging power output from the charging device 110 is greater than about 3.3 kW, the controller 130 may be configured to determine that the charging device 110 is configured with an EVSE or that the charging device 110 outputs high power, and thus the power factor correction circuit 120 may be operated to distribute charging power to a plurality of phases. Accordingly, the optimum charging efficiency according to charging power may be maintained.

In addition, when receiving an allowable charging current duty ratio signal from the charging device 110, the controller 130 may be configured to set the preset value to a duty ratio corresponding to about 3.3 kW, which is a reference for determination of low power. In other words, when the allowable charging current duty ratio of the charging device 110 is equal to or less than the preset value, the controller 130 may be configured to determine that the charging device 110 is configured with an ICCB or that the charging device 110 outputs low power, and thus the power factor correction circuit 120 may be operated to cause charging current to flow to one phase. In contrast, when the allowable charging current duty ratio of the charging device 110 is greater than the preset value, the controller 130 may be configured to determine that the charging device 110 is configured with an EVSE or that the charging device 110 outputs high power, and thus the power factor correction circuit 120 may be operated to distribute charging power to a plurality of phases, to maintain the optimum charging efficiency according to allowable charging current duty ratios. The preset power and preset value limited by specified numerals in the aforementioned examples are merely values according to an exemplary embodiment, and such values may be varied and applied by a designer.

Actually, referring to FIG. 4, it may be understood that, as charging power applied to the power factor correction circuit 120 increases, the charging efficiency increases; and it may be understood that the efficiency of charging power is the maximum in a power section of an intermediate value, and is reduced in high/low power sections. For this reason, it may be possible to improve the charging efficiency by preventing low power from being applied to each phase of the power factor correction circuit 120, as described in accordance with the exemplary embodiments of the present invention.

Meanwhile, in accordance with an exemplary embodiment of the present invention, the controller 130 may be configured to measure the voltage of a rear terminal of the charging device 110, and calculate an effective voltage value based on the measured voltage. The effective voltage value may be calculated using alternating current voltage output from the charging device 110, and may be an index that represented the average magnitude of applied voltages. Generally, as the effective voltage value increases, charging power may increase.

When the charging power of the charging device 110 is less than preset power, and the effective voltage value is equal to or greater than a preset voltage, the controller 130 may be configured to operate the power factor correction circuit 120 to distribute charging power to some of the multiple phases. When the allowable charging current duty ratio of the charging device 110 is less than a preset value, and the effective voltage value is equal to or greater than a preset voltage, the controller 130 may be configured to operate the power factor correction circuit 120 to distribute charging power to a part of multiple phases.

In particular, the preset voltage may be set to half of a target effective voltage value. For example, in the case in which a target voltage to be applied from the power source 140 is about 320 V, when a voltage of about 180 V or less is applied, the charging power may be measured to be less than the target power causing difficult in accurately determining whether the charging device 110 uses an EVSE scheme or an ICCB scheme. For this reason, the controller 130 may be configured to set the preset voltage to about 180 V; and when the effective voltage value is equal to or greater than the preset voltage, the controller 130 may be configured to determine that the effective voltage value has more stably arrived at the target voltage, and perform a control based on the charging power of allowable charging current duty ratio of the charging device 110. Accordingly, the reliability of the control may be improved.

FIG. 5 illustrates an area in which the controller 130 operates the power factor correction circuit 120 in a single-phase PWM scheme in a connection between the effective voltage value and the charging power, and FIG. 6 illustrates an area, with hatching, in which the controller 130 operates the power factor correction circuit 120 in a single-phase PWM scheme in a connection between the effective voltage value and the allowable charging current duty ratio.

According to an apparatus for charging a battery for a vehicle, having a configuration as described above, since the power factor correction circuit may be switched to a single-phase PWM scheme based on the type of a charging device, the charging power thereof, or the allowable charging current duty ratio thereof, when charging power is substantially low, a switching loss and a diode on-drop may be reduced in comparison with the prior art using a two-phase interleaved PWM scheme, to improve the charging efficiency.

In addition, a charging efficiency higher than the conventional efficiency may be achieved, to improve the fuel efficiency of a vehicle, reduce a charging time, and reduce electric charge. In addition, since the present invention may be implemented with the conventional apparatus for charging a battery for a vehicle, even without a separate device added thereto, and a cause of rising cost due to a topology change and added hardware may be removed. In addition, since one of two phases of the power factor correction circuit is used, the use amount of the other phase may be reduced by about half, to increase the durability of the power factor correction circuit.

While the present invention has been described with respect to the specific exemplary embodiments, it will be apparent to those skilled in the art that various changes and modifications may be made without departing from the spirit and scope of the invention as defined in the following claims.

What is claimed is:

1. An apparatus for charging a battery for a vehicle, comprising:
a power factor correction circuit configured to distribute charging power output from a charging device, connected to a power source, to multiple phases, and to correct a power factor of charging power distributed to the respective phases; and
a controller configured to operate the power factor correction circuit to distribute charging power to some of the multiple phases based on the charging device or the charging power of the charging device.

2. The apparatus of claim 1, wherein the controller is configured to operate the power factor correction circuit to distribute charging power to some of the multiple phases when the charging device is an in-cable control box (ICCB).

3. The apparatus of claim 1, wherein the controller is configured to operate the power factor correction circuit to distribute charging power to some of the multiple phases when the charging power is less than a preset power.

4. The apparatus of claim 1, wherein the controller is configured to operate the power factor correction circuit to distribute charging power to some of the multiple phases when an allowable charging current duty ratio of the charging device is less than a preset value.

5. The apparatus of claim 1, wherein the controller is configured to measure the voltage of a rear terminal of the charging device, and to calculate an effective voltage value based on the measured voltage.

6. The apparatus of claim 5, wherein the controller is configured to operate the power factor correction circuit to distribute charging power to some of the multiple phases when the charging power of the charging device is less than a preset power and the effective voltage value is equal to or greater than a preset voltage.

7. The apparatus of claim 5, wherein the controller is configured to operate the power factor correction circuit to distribute charging power to some of the multiple phases when an allowable charging current duty ratio of the charging device is less than a preset value and the effective voltage value is equal to or greater than a preset voltage.

8. A method for charging a battery for a vehicle, comprising:
operating, by a controller, the power factor correction circuit to distribute charging power output from a charging device, connected to a power source, to some of a multiple phases based on the charging device or charging power of the charging device.

9. The method of claim 8, further comprising:
operating, by the controller, the power factor correction circuit to distribute charging power to some of the multiple phases when the charging device is an in-cable control box (ICCB).

10. The method of claim 8, further comprising:
operating, by the controller, the power factor correction circuit to distribute charging power to some of the multiple phases when the charging power is less than a preset power.

11. The method of claim 8, further comprising:
measuring, by the controller, the voltage of a rear terminal of the charging device, and to calculate an effective voltage value based on the measured voltage.

12. The method of claim 11, further comprising:
operating, by the controller, the power factor correction circuit to distribute charging power to some of the multiple phases when the charging power of the charging device is less than a preset power and the effective voltage value is equal to or greater than a preset voltage.

13. The method of claim 11, further comprising:
operating, by the controller, the power factor correction circuit to distribute charging power to some of the multiple phases when an allowable charging current duty ratio of the charging device is less than a preset value and the effective voltage value is equal to or greater than a preset voltage.
